(19) United States
(12) Patent Application Publication
(10) Pub. No.: US 2010/0316853 A1
(43) Pub. Date: Dec. 16, 2010

(54) AIRCRAFT WITH PAINTED EXTERIOR SURFACE AND DECORATIVE FILM

(75) Inventors: Birgit KUHLENSCHMIDT, Hamburg (DE); Karl HAUSMANN, Hamburg (DE); Rolf BENSE, Jork (DE); Rebecca SIEWERT, Hamburg (DE); Daniel LAHIDJANIAN, Hamburg (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: AIRBUS DEUTSCHLAND GMBH, Hamburg (DE)

(21) Appl. No.: 12/781,107

(22) Filed: May 17, 2010

Related U.S. Application Data
(60) Provisional application No. 61/178,685, filed on May 15, 2009.

(30) Foreign Application Priority Data
May 15, 2009 (DE) 10 2009 021 610.3

(51) Int. Cl. B32B 3/10

(52) U.S. Cl. 428/203

(57) ABSTRACT

An aircraft includes a fuselage having a painted exterior surface having a first color; a decorative film including plastic and having a second color different from the first color and adhesively bonded to the fuselage, wherein the decorative film includes at least one of a polyvinyl fluoride film, a polyester film, a polyvinyl chloride film, a polyethylene film, and a polypropylene film, wherein the decorative film is formable via one of polymerization, polyaddition and polycondensation; and a layer of clear paint containing a UV filter for erosion protection and covering the decorative film.

CROSS REFERENCE TO PRIOR APPLICATIONS

Priority is claimed to German Application No. DE 10 2009 021 610.3, filed May 15, 2009 and U.S. Provisional Application No. 61/178,685, filed May 15, 2009. The entire disclosure of both applications is incorporated by reference herein.

The invention relates to an aircraft with a painted exterior surface, which is formed by at least a fuselage or airframe and aerodynamic flight means arranged thereupon, on which at least one different colored decorative film made of plastic is applied.

The area of application of the present invention extends primarily to aircraft for transporting people or goods, the aerodynamic flight means on which are essentially comprised of airfoils and rudder units as well as elevator units. Decorative films are used primarily in the area of the fuselage as well as the rudder unit in order to apply ornamented patterns and lines along with logos taking the form of monochrome color surfaces or color progressions ranging all the way to image motifs. In addition to aircraft of the kind described above, the solution according to the invention can also be applied for other aircraft, such as helicopters, gliders, and the like, which have a painted exterior surface to be covered by decorative films.

### BACKGROUND

Disclosed in DE 10 2004 044 655 A1 are various technical solutions for designing color or image surfaces on the exterior surface of an aircraft. Fabrication via spray painting with color paints requires that those areas on the exterior surface that are not to be painted be masked beforehand. The masking technique requires a special manual dexterity, for example to obtain clean colored edges after removing the masking tape and films. In addition, spray painting involves a cumbersome vacuuming of solvent vapors and special occupational safety measures. Further, the painting technique requires a time-intensive intermediate drying of the individual coats of paint to be applied one after the other. Therefore, it is recommended that spray painting be performed with an automatic painting device by having a guiding device guide a paint discharging device along the curved surface of the aircraft fuselage.

As an alternative hereto, this prior art describes the application of decorative film on the exterior surface of the aircraft. While the problems outlined above are avoided through the use of adhesively bonded decorative film, the previously used decorative film cannot be erosion resistant due to the materials, and are softened and degraded in particular by hydraulic fluid (e.g., Skydrol®), kerosene or other aggressive media. However, resistance to media is an absolute precondition in aircraft construction for the coating of exterior surfaces. While media-resistant decorative films do exist, these in turn have disadvantages relative to the compatibility with airplane paints, which are used for painting the exterior surface of an aircraft. For these reasons, the expert community as a rule did not recommend the use of decorative films in the aircraft of interest here.

### SUMMARY OF THE INVENTION

An aspect of the present invention is to provide aircraft of the generic kind with easy-to-apply decorative films for the application of color or picture areas on the exterior surface, which remain colorfast, erosion resistant and Skydrol proof for a long time.

The invention infers the technical instruction that the special decorative film is a polyvinyl fluoride film (PVF), a polyester film (PE), a polyvinyl chloride film (PVC) or a polyethylene film (PET), a polypropylene film (PP), or a mixed polymer consisting of at least two of the above components, which is generated via polymerization, polyaddition or polycondensation, and which is covered by a clear layer of paint containing a UV filter for purposes of erosion protection.

The advantage of the solution according to the invention lies in particular in the fact that it eliminates expensive masking operations by comparison with conventional painting technology, lowering the manufacturing costs in this regard. In addition, this film can be provided, for example imprinted, with an image motif, independently of the manufacturing status of the airplane, meaning that this makes it possible to parallelize manufacturing processes. The use of decorative films enables a constant quality of the color or image surfaces generated therewith. The solution according to the invention is based on the knowledge that the mentioned plastic materials can be covered by a coating of clear paint without the coating of clear paint resulting in any signs of detachment, such as blistering, discolorations and the like. Since the clear paint selected blocks ultraviolet radiation at least for the most part, an additional effective UV filter is generated, which protects the decorative film against a radiation-induced change in material properties. Contrary to the preconception on the part of the expert community, then, the solution according to the invention offers a system comprised of special plastic materials for the decorative film and a clear paint for imparting color to the exterior surface of an aircraft.

The decorative film most preferably consists of a non-perforated PVC or a mixed polymer consisting of PE, PP and PET material.

In a measure that improves upon the invention, it is proposed that the decorative film, before applied to the exterior surface of the aircraft, be coated with an image motif that can consist of ink or color paint. In a first alternative, it is hence proposed that the decorative film be imprinted with ink. In a second alternative, the decorative film can also be sprayed with color paint for generating image motifs. The manufacturing technique here depends on the image motif to be generated. The decorative film not only makes it possible to generate monochrome surfaces, but also multi-color surfaces with merging color progressions or even photo-like image motifs. The decorative film can be provided with an image motif in a corresponding preliminary processing step, meaning with lettering, trim lines, logos or photo-like image motifs.

In another measure that improves upon the invention, it is proposed that the decorative film be coated with a primer to impart adhesion relative to the motif to be applied hereupon. This manufacturing step takes place before the motif is applied to the decorative film. The primer ensures a reliable adhesion of the motif to the decorative film. Instead of a primer coating, use can also be made of plasma pre-treatment or corona pre-treatment.

In a measure that further simplifies processing, it is proposed that the decorative film be pressure-sensitive on the side facing the exterior surface. The pressure-sensitive layer should be covered with a carrier paper that can be removed in a known manner prior to application on the exterior surface of the aircraft, so as to then be able to cleanly glue on the decorative film.

In conjunction with the final clear paint layer to be applied, it is proposed that the decorative film have a 10 to 130 micrometer [thickness]. In this special thickness range, the decorative film ahs a sufficiently high resistance to tearing and deformation on the one hand, so that it can also be applied to larger surfaces, while the decorative film is also think enough to be reliably covered by the clear paint coating on the other.

The clear paint layer should preferably consist of a polyurethane (PUR) paint, for example one applied via spray painting. Spray painting can take place automatically to achieve a high surface quality. The special paint establishes the required protection against aggressive media, UV radiation and erosion, and is also characterized by a high material compatibility relative to the decorative film.

In conjunction with the thickness range indicated above for the decorative film, the clear paint layer should have a thickness of between 30 and 120 micrometers, so that it can provide stable protection against erosion. This would not be ensured if the clear paint layer were too thin. On the other hand, too thick of a clear paint layer would disadvantageously increase the overall weight of the aircraft, and bring about the risk of runner formation during spray painting.

The coating solution according to the invention is suitable in particular for airplanes used to transport passengers and goods, which are usually provided with single or multi-color image motifs, such as ornamented patterns, ornamented lines and corporate logos.

### BRIEF DESCRIPTION OF THE DRAWINGS

Other measures that improve the invention will be described in greater detail below in conjunction with the description of a preferred exemplary embodiment of the invention based on the figures. Shown on:

FIG. 1 is a side view of an aircraft in the form of a passenger airliner with decorative film applied thereto, and

FIG. 2 is a diagrammatic cross sectional view of the layered structure in the area of the decorative film.

### DETAILED DESCRIPTION

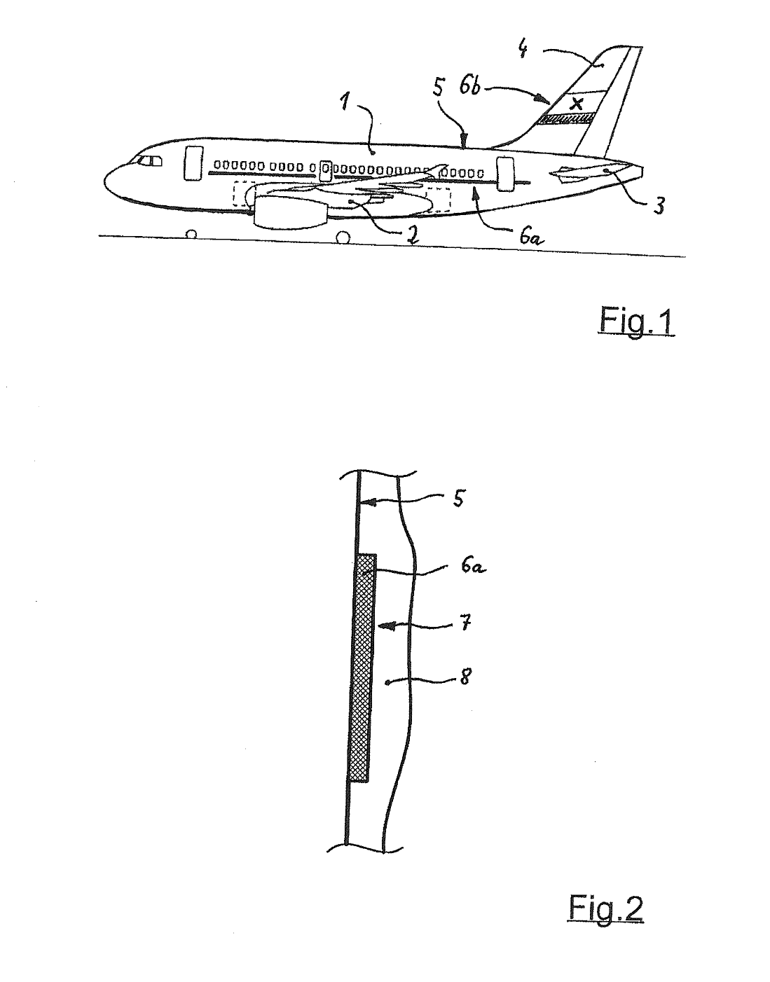

According to FIG. 1, an aircraft designed as a passenger airliner in the form of a commercial airplane has a fuselage 1, the sides of which each carry a wing 2 as the aerodynamic flight means with engines. The rear of the fuselage 1 has an elevator unit 3, along with a rudder unit 4 that upwardly projects far from the fuselage 1. In particular the exterior surface 5 in the area of the fuselage 1 and the rudder unit 4 is suitable for the application of decorative films 6a and 6b. The decorative films 6a and 6b consist of a plastic described in greater detail below, and are adhesively bonded to the exterior surface 5 of the aircraft.

The decorative film 6a is designed in the form of a monochrome decorative strip, which is distinguished in terms of its color from the exterior surface 5 of the fuselage 1, which is painted white here. By contrast, the decorative film 6b applied to the rudder unit 4 is a mix of various color ranges that together comprise a logo.

As an example, FIG. 2 shows a cross section through the decorative film 6a adhesively bonded to the exterior surface 5, which forms a decorative strip. The decorative film 6a consists of a special plastic, specifically a PVC material here. The decorative film 6a is pressure-sensitive relative to the exterior surface 5 of the aircraft, and subsequently coated with a thin layer of primer 7 to impart adhesion relative to an image motif 9 imprinted hereupon.

The clear paint layer 8 is applied via spray painting, and contains a UV filter for protecting the underlying decorative film 6a against changes in material properties. In addition, the clear paint layer 8 in the hardened state provides effective mechanical protection against erosion. PUR paint is used as the clear paint.

Let it additionally be noted that “encompassing” does not preclude any other elements or steps, and that “an” or “a” do not rule out a plurality. Further, let it be noted that features or steps that were described with reference to one of the above exemplary embodiments can also be used in combination with other features or steps from other exemplary embodiments described above. Reference numbers in the claims are not to be construed as a limitation.

### REFERENCE LIST

1 Fuselage

2 Wing

3 Elevator unit

4 Rudder unit

5 Exterior surface

6 Decorative film

7 Primer

8 Clear paint layer

9 Image motif

What is claimed is:

1. An aircraft comprising:
a fuselage having a painted exterior surface having a first color;
a decorative film including plastic and having a second color different from the first color and adhesively bonded to the fuselage, wherein the decorative film includes at least one of a polyvinyl fluoride film, a polyester film, a polyvinyl chloride film, a polyethylene film, and a polypropylene film, wherein the decorative film is formable via one of polymerization, polyaddition and polycondensation; and
a layer of clear paint containing a UV filter for erosion protection and covering the decorative film.

2. The aircraft as recited in claim 1, wherein the decorative film includes a non-perforated polyvinyl chloride film.

3. The aircraft as recited in claim 1, wherein the decorative film is coated with an image motif including one of ink and color paint.

4. The aircraft as recited in claim 1, wherein the decorative film is coated with a primer configured to activate the decorative film.

5. The aircraft as recited in claim 1, wherein the decorative film is pressure-sensitive on a side facing the painted exterior surface.

6. The aircraft as recited in claim 1, wherein the decorative film has a thickness between 10 and 130 micrometers.

7. The aircraft as recited in claim 1, wherein the clear layer of paint includes a polyurethane paint configured to be applied via spray painting.

8. The aircraft as recited in claim 1, wherein the clear layer of paint includes a thickness between 30 and 130 micrometers.

9. The aircraft as recited in claim 1, further comprising a rudder unit having two rudder exterior surfaces and two additional decorative films disposed on each of the two rudder exterior surfaces.

10. An aircraft comprising:
a rudder unit having a painted exterior surface having a first color;
a decorative film including plastic and having a second color different from the first color and adhesively bonded to the exterior surface, wherein the decorative film includes at least one of a polyvinyl fluoride film, a polyester film, a polyvinyl chloride film, a polyethylene film, and a polypropylene film, wherein the decorative film is formable via one of polymerization, polyaddition and polycondensation; and
a layer of clear paint containing a UV filter for erosion protection and covering the decorative film.
